(19) United States
(12) Patent Application Publication
(10) Pub. No.: US 2025/0301265 A1
(43) Pub. Date: Sep. 25, 2025

(54) Speaker

(71) Applicant: AAC Microtech (Changzhou) Co., Ltd., Changzhou (CN)

(72) Inventor: Chao Zhang, Changzhou (CN)

(21) Appl. No.: 18/743,094

(22) Filed: Jun. 13, 2024

Related U.S. Application Data
(63) Continuation of application No. PCT/CN2024/083562, filed on Mar. 25, 2024.

(51) Int. Cl. H04R 9/06; H04R 1/02; H04R 7/04; H04R 7/18; H04R 9/02; H04R 9/04

(52) U.S. Cl. CPC H04R 9/06; H04R 1/023; H04R 7/04; H04R 7/18; H04R 9/025; H04R 9/045; H04R 2400/11

(57) ABSTRACT

The present invention provides a speaker includes a frame, a vibration system fixed with the frame, a magnetic circuit system driving the vibration system to vibrate and sound, a flexible circuit board and an electrical connector. The vibration system includes a diaphragm and a voice coil driving the diaphragm to vibrate. The flexible circuit board is fixed on a side of the diaphragm distal to the voice coil. The flexible circuit board covers and is fixed with the diaphragm. The electrical connector passes through the diaphragm to electrically connect the flexible circuit board and the voice coil. In present invention, the flexible circuit board does not occupy a space of the magnetic circuit system, and the acoustic performance of the speaker is good.

### FIELD OF THE PRESENT INVENTION

The present invention relates to the field of electro-acoustic conversion, and more particularly, to a speaker.

### DESCRIPTION OF RELATED ART

In recent years, with the rapid development of mobile communication technology, consumers are increasingly using mobile communication devices with voice functions, such as portable phones, handheld game consoles, laptops, multimedia players and other devices that can communicate through public or private communication networks. The speaker as a voice function playback device, its internal magnetic circuit system is directly related to the improvement of the acoustic performance of the product.

In related art, the flexible circuit board of the speaker is arranged on the four rounded corners or four sides of the voice coil, and the flexible circuit board needs to occupy part of the space of the magnetic circuit system, which affects the driving force of the speaker and causes the speaker distortion.

Therefore, it is desired to provide a new speaker which can overcome the above problems.

### SUMMARY

In view of the above, the embodiments of the present invention provide a new speaker having a strong driving force and good acoustic performance.

The present invention provides a speaker includes a frame, a vibration system fixed with the frame, a magnetic circuit system driving the vibration system to vibrate and sound, a flexible circuit board and an electrical connector. The vibration system includes a diaphragm and a voice coil driving the diaphragm to vibrate. The flexible circuit board is fixed on a side of the diaphragm distal to the voice coil. The flexible circuit board covers and is fixed with the diaphragm. The electrical connector passes through the diaphragm to electrically connect the flexible circuit board and the voice coil.

As an improvement, the flexible circuit board includes an inner ring portion secured with the diaphragm, an outer ring portion secured with the frame, and a connection portion connecting the inner ring portion and the outer ring portion.

As an improvement, the flexible circuit board is fixed on the diaphragm by glue.

As an improvement, the electrical connector locates at a junction of the inner ring portion and the connection portion.

As an improvement, the electrical connector includes an upper surface close to the flexible circuit board and a lower surface away from the flexible circuit board, the upper surface electrically connected with the lower surface, the upper surface electrically connected with the flexible circuit board, the lower surface electrically connected with the voice coil, and the flexible circuit board electrically connected with an external circuit.

As an improvement, the electrical connector is made by one or more of graphene, carbon nanotubes, carbon nanofibers, silver powder, and liquid metal.

As an improvement, the diaphragm includes a dome, a plane portion arranged under the inner ring portion, a suspension arranged around the plane portion, and a fixing portion fixed with the frame, the electrical connector embedded in the plane portion.

As an improvement, a number of the electrical connectors is two, and the two electrical connectors are centrosymmetric arranged around a geometric center point of the diaphragm, the dome including a first opening avoiding the electrical connector, the plane portion including a second opening avoiding the electrical connector, the first opening communicated with the second opening.

As an improvement, the suspension includes four corners, and the suspension further includes a plurality of folds disposed on each corner and arranged apart from each other, the plurality of the folds distributed radially along a direction from an inner edge to an outer edge of the suspension.

As an improvement, the speaker further includes a front cover mounted with the frame, and the flexible circuit board is sandwiched between the front cover and the diaphragm.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a speaker in accordance with one embodiment of the present invention.

FIG. 2 is an exploded view of the speaker of FIG. 1.

FIG. 3 is an illustrative isometric view of the speaker of FIG. 1 removing the front cover.

FIG. 4 is an illustrative cross-sectional view of the speaker taken along line A-A of FIG. 1.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

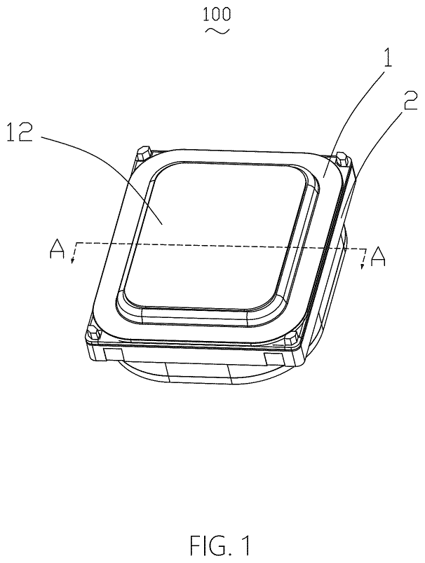

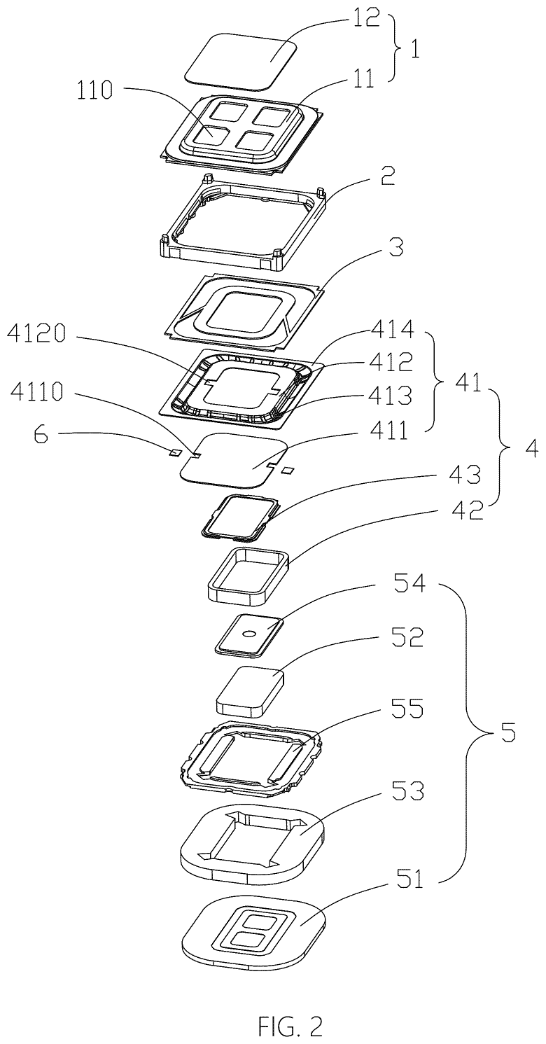

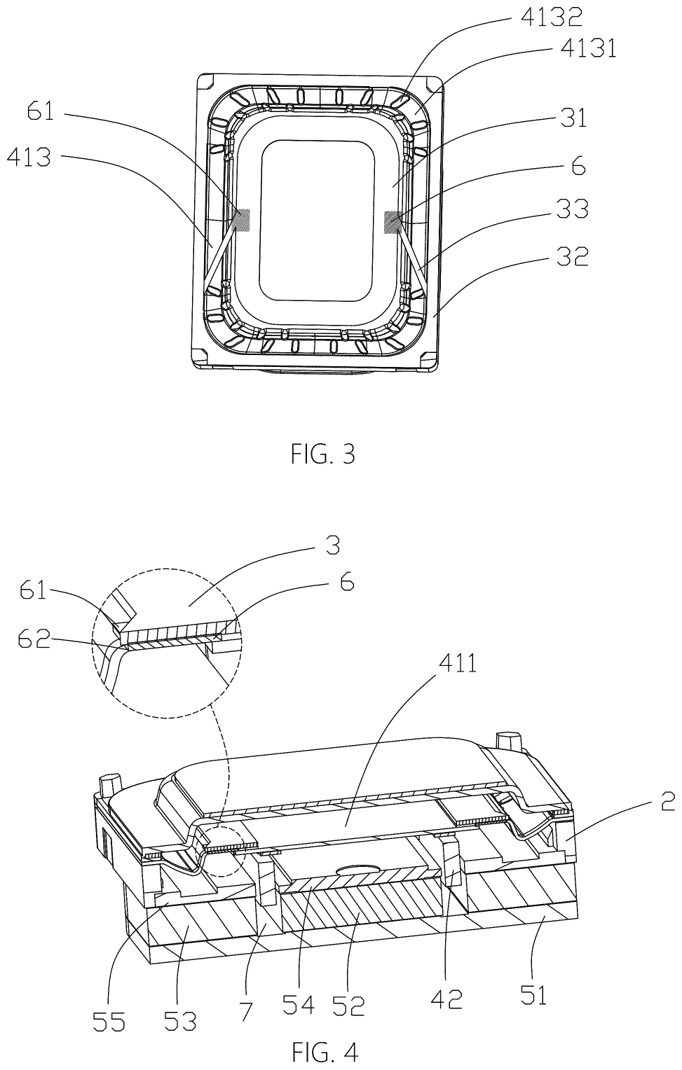

Referring to the FIGS. 1-4, the present invention provides one embodiment of a speaker 100. The speaker 100 includes a front cover 1, a frame 2 fixed with the front cover 1, a flexible circuit board 3 secured with the frame 2, a vibration system 4 fixed with the frame 2, a magnetic circuit system 5 driving the vibration system 4 to vibrate and sound, and an electrical connector 6 electrically connected with the flexible circuit board 3.

The front cover 1 includes a main part 11 and a mesh 12 attached on the main part 11. The main part 11 has a plurality of holes 110, and the mesh 12 covers the holes 110.

The flexible circuit board 3 includes an inner ring portion 31, an outer ring portion 32 secured with the front cover 1, and a connection portion 33 connecting the inner ring portion 31 and the outer ring portion 32. The connecting portion 33 has a linear strip structure. The inner ring portion 31, the outer ring portion 32, and the connecting portion 33 are integrated into a whole structure. The outer ring portion 32 is sandwiched between the front cover 1 and the frame 2. In other embodiments, the connecting portion 33 may also have a curved strip shape or have other shapes.

The vibration system 4 includes a diaphragm 41, a voice coil 42 driving the diaphragm 41 to vibrate, and a voice coil support 43 connecting the diaphragm 41 and the voice coil 42.

The flexible circuit board 3 covers and is fixed with the diaphragm 41. The flexible circuit board 3 is fixed on a side of the diaphragm 41 distal to the voice coil 42 by glue. The flexible circuit board 3 does not occupy a space of the magnetic circuit system 5, and a driving force of the speaker 100 is improved, and furthermore, the acoustic performance of the speaker 100 is improved. In detail, the inner ring portion 31 of the flexible circuit board 3 is secured with the diaphragm 41, and the outer ring portion 32 of the flexible circuit board 3 also can be sandwiched between the front cover 1 and the diaphragm 41.

The diaphragm 41 includes a dome 411, a plane portion 412 located above the dome 411, a suspension 413 arranged around the plane portion 412, and a fixing portion 414 fixed with the frame 2. The plane portion 412, the suspension 413, and the fixing portion 414 are integrated into a whole structure. The inner ring portion 31 of the flexible circuit board 3 is attached to the plane portion 412. The dome 411 includes a first opening 4110 avoiding the electrical connector 6, and the plane portion 412 includes a second opening 4120 avoiding the electrical connector 6. The first opening 4110 is communicated with the second opening 4120.

The suspension 413 includes four corners 4131, and the suspension 413 further includes a plurality of folds 4132 disposed on each corner 4131 and arranged apart from each other. The plurality of the folds 4132 are distributed radially along a direction from an inner edge to an outer edge of the suspension 413.

The magnetic circuit system 5 includes a magnetic yoke 51, a main magnet 52 located on the magnetic yoke 51, and an auxiliary magnet 53 arranged around the main magnet 52. A magnetic gap 7 is formed between the main magnet 52 and the auxiliary magnet 53. The voice coil 42 at least locates in the magnetic gap 7. The magnetic circuit system 5 further includes a main pole plate 54 mounted on the main magnet 52 and an auxiliary pole plate 55 mounted on the corresponding auxiliary magnet 53. The auxiliary pole plate 55 is fixed with the frame 2.

The electrical connector 6 passes through the diaphragm 41 to electrically connect the flexible circuit board 3 and the voice coil 42. The electrical connector 6 is embedded in the plane portion 412 of the diaphragm 41. The electrical connector 6 locates under a junction of the inner ring portion 31 and the connection portion 33 of the flexible circuit board 3. The electrical connector 6 includes an upper surface 61 close to the flexible circuit board 3 and a lower surface 62 away from the flexible circuit board 3. The upper surface 61 is electrically connected with the lower surface 62. Specifically, the upper surface 61 is electrically connected with the flexible circuit board 3, the lower surface 62 is electrically connected with the voice coil 42, and the flexible circuit board 3 is electrically connected with an external circuit. In this way, the voice coil 42 is electrically connected with the external circuit.

In one embodiment, the electrical connector 6 is made of conductive material. The electrical connector 6 is made by one or more of graphene, carbon nanotubes, carbon nanofibers, silver powder, and liquid metal. A number of the electrical connectors 6 is two, and the two electrical connectors 6 are centrosymmetric arranged around a geometric center point of the diaphragm 41.

Comparing with the related art, the present invention provides a speaker includes a frame, a vibration system fixed with the frame, a magnetic circuit system driving the vibration system to vibrate and sound, a flexible circuit board and an electrical connector. The vibration system includes a diaphragm and a voice coil driving the diaphragm to vibrate. The flexible circuit board is fixed on a side of the diaphragm distal to the voice coil. The flexible circuit board covers and is fixed with the diaphragm. The electrical connector passes through the diaphragm to electrically connect the flexible circuit board and the voice coil. In present invention, the flexible circuit board covers and fixes on the side of the diaphragm distal to the voice coil, and the flexible circuit board does not occupy a space of the magnetic circuit system. The driving force of the speaker is improved, and furthermore, the acoustic performance of the speaker is improved.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker, comprising:
a frame;
a vibration system fixed with the frame, the vibration system comprising:
a diaphragm; and
a voice coil driving the diaphragm to vibrate;
a magnetic circuit system driving the vibration system to vibrate and sound;
a flexible circuit board fixed on a side of the diaphragm distal to the voice coil, the flexible circuit board covering and fixed with the diaphragm; and
an electrical connector passing through the diaphragm to electrically connect the flexible circuit board and the voice coil.

2. The speaker as described in claim 1, wherein the flexible circuit board comprises an inner ring portion secured with the diaphragm, an outer ring portion secured with the frame, and a connection portion connecting the inner ring portion and the outer ring portion.

3. The speaker as described in claim 2, wherein the flexible circuit board is fixed on the diaphragm by glue.

4. The speaker as described in claim 2, wherein the electrical connector locates at a junction of the inner ring portion and the connection portion.

5. The speaker as described in claim 2, wherein the electrical connector comprises an upper surface close to the flexible circuit board and a lower surface away from the flexible circuit board, the upper surface electrically connected with the lower surface, the upper surface electrically connected with the flexible circuit board, the lower surface electrically connected with the voice coil, and the flexible circuit board electrically connected with an external circuit.

6. The speaker as described in claim 5, wherein the electrical connector is made by one or more of graphene, carbon nanotubes, carbon nanofibers, silver powder, and liquid metal.

7. The speaker as described in claim 5, wherein the diaphragm comprises a dome, a plane portion arranged under the inner ring portion, a suspension arranged around the plane portion, and a fixing portion fixed with the frame, the electrical connector embedded in the plane portion.

8. The speaker as described in claim 7, wherein a number of the electrical connectors is two, and the two electrical connectors are centrosymmetric arranged around a geometric center point of the diaphragm, the dome comprising a first opening avoiding the electrical connector, the plane portion comprising a second opening avoiding the electrical connector, the first opening communicated with the second opening.

9. The speaker as described in claim 7, wherein the suspension comprises four corners, and the suspension further comprises a plurality of folds disposed on each corner and arranged apart from each other, the plurality of the folds distributed radially along a direction from an inner edge to an outer edge of the suspension.

10. The speaker as described in claim 1, wherein the speaker further comprises a front cover mounted with the frame, and the flexible circuit board is sandwiched between the front cover and the diaphragm.
